(19) United States
(12) Patent Application Publication
(10) Pub. No.: US 2008/0262140 A1
(43) Pub. Date: Oct. 23, 2008

(54) Thermoplastic Polyolefin Alloys and Process for Their Preparation

(75) Inventors: Sodagudi Francis Xavier, Gujarat (IN); Pendyala Veera Nageswara Sastry, Gujarat (IN)

Correspondence Address: LADAS & PARRY LLP, 26 WEST 61ST STREET, NEW YORK, NY, 10023, US

(73) Assignee: INDIAN PETROCHEMICALS CORPORATION LIMITED, Gujarat (IN)

(21) Appl. No.: 10/586,022

(22) PCT Filed: Jan. 16, 2004
(86) PCT No.: PCT/IN2004/000011

§ 371 Date: Jun. 26, 2008

(51) Int. Cl. C08L 53/00; C08K 3/26; C08K 3/34

(52) U.S. Cl. 524/427; 525/88; 525/89; 524/505; 524/449; 524/451

(57) ABSTRACT

A thermoplastic polyolefin alloy having high (notched) Izod impact strength and process for its preparation are disclosed. The alloys of this invention comprises of a polypropylene block copolymer as a base polymer, an elastomer, a compatibilizer and optionally a natural filler and is prepared by melt blending a twin-screw extruder (or Buss-co-kneader) the above ingredients. The polyolefin alloys of this invention exhibit very high (notched) Izod impact strength of 60 to 90 kg. cm/cm, flexural modulus of 6,000 to 8,000 kg/cm2, tensile strength at yield of 150 to 200 kg/cm2, and heat deflection temperature of 60 to 70° C. with 4.6 kgf stress. The alloys also possess melt flow index of 2-5 g/10 min. when tested according to ASTM D1238 and allow injection molding, compression molding, thermoforming and other conventional techniques to be applied for making end products that demand high impact strength.

### FIELD OF INVENTION

The present invention relates to improved thermoplastic polyolefin alloys. In particular, the present invention relates to compatibilized polypropylene copolymer blends prepared by melt blending in a co-rotating twin-screw extruder (or Buss-co kneader). The compatibilized blends of this invention exhibit very high notched Izod impact strength at moderate concentration of elastomer and a suitable compatibilizer along with/without a natural filler. The present invention also relates to process for preparing improved thermoplastic polyolefin alloys.

### BACKGROUND OF THE INVENTION

Polymer blends have gained significant commercial growth in the last 2-3 decades outpacing the growth rate of existing polymers by at least 2-5%. Commercial polymer blends are either designed or selected to have some degree of compatibility between the components to resist delamination and loss in ductility. Compatibility is to be viewed here as the ability for the polymer components to co-exist either as molecularly miscible or morphologically distinct phases but interfacially stabilized blends, without a tendency for delamination.

Compatibilization of highly immiscible commercial polymer pairs has thus far been a technically more challenging task for the polymer blends technologists in the industry. Significant progress has, however, been made in recent years in utilizing compatibilizers based on graft or block copolymer or other interfacial agents that effectively reduce the interfacial tension between the components to achieve useful levels of ductility and delamination resistance, while at the same time stabilizing the morphology against processing effects. Interfacial compatibilization in commercial polymer blends is generally achieved through reactive extrusion in which the block or graft copolymer compatibilizer is generated in situ at the interface during the melt blending.

Many commercial polymer blends often include an elastomer to improve the impact strength of the blends under conditions of stress concentration. The elastomeric dispersions are judiciously employed within the matrix phase or in the dispersed polymer phase or in both the phases, depending upon the requirement and the fracture behavior of the blend. An overwhelming factor in determining the impact strength of an immiscible or partially miscible blend is the degree and efficiency of interfacial compatibilization that either is inherent in or has been designed into the blend system. If the interfacial adhesion or compatibilization is poor, the elastomer dispersion alone will not improve the toughness. Combining a high level of (notched) Izod impact strength with moderate stiffness has been the primary thrust of this invention.

There have been several innovations in this area and many patents have been granted. U.S. Pat. No. 5,030,694 (1991) granted to Kelley, J. M., describes blends of ethylene-propylene copolymer and EPDM along with some organic peroxide exhibiting appreciable melt flow, impact strength and flexural modulus properties. EP Patent No. 132, 968 (1985) granted to Mitsui Petrochemical Industries Ltd., teaches blends of ethylene-propylene copolymer with a random ethylene-α-olefin copolymer rubber along with natural filler such as talc offering good impact as well as rigidity properties. GB 2,246,358 (1992) sanctioned to Nissan Motor Co. Ltd. and Mitsubishi Petrochemical Co. Ltd. describes the blends of ethylene-propylene copolymer with EPR and talc exhibiting excellent flow, impact and flexural properties. EP 435,247 (1991) granted to Nippon Petrochemicals Co. Ltd. and Nippon Oil and Fats reveals blends of polypropylene and multi-phase propylene-vinyl monomer graft copolymer offering good moldability, heat as well as impact resistance. German Patent DE 3,520,151 (1986) granted to Dynamic Nobel, AG, describes blends of partially crystalline EP polymer, polypropylene homo or copolymer and polyethylene along with organic peroxide exhibiting high impact and good weather resistance properties. JP 04,258,652 (1992) granted to Mitsui Toatsu Chemicals Inc., reveal the preparation of syndiotactic PP and ethylene-properties copolymer blends exhibiting high impact strength and transparency. Similar properties were exhibited by the blends of propylene polymers and thermoplastic elastomers along with aromatic phosphorous compound metal salts described in JP 04,96,947 (1992) granted to Mitsui Toatsu Kagaku, K.K. JP 03,252,436 (1991) issued to Tonen Chemical Corporation and Toyota Motor Corporation describes blends of ethylene-propylene block copolymer, EPR, non-crystalline Nylon and modified PP exhibiting good heat and impact resistance properties. JP 03,168,233 (1991) granted to Idemitsu Petrochemical Co. Ltd., describes a blend of PP and elastomer exhibiting improved impact strength and weather resistance. Japan Synthetic Rubber Co. Ltd., received a patent JP 02,191,656 (1990) for their blend of thermoplastic resins, rubbers, cross-linking monomers and other additives exhibiting appreciable impact strength. The same company was granted another patent JP 02,49,043 (1990) for their polyolefin blend with resistance properties. Innovations for high impact materials were also made with nonpolyolefinic materials. EP 297,517 (1989) granted to Idemitsu Petrochemical Co. Ltd., and Nippon Zeon Co. Ltd., describes blends of polycarbonate and graft copolymer obtained from vinyl/polyfunctional vinyl monomers exhibiting good low temperature impact resistance and solvent resistance properties. U.S. Pat. No. 4,673,722 (1987) issued to General Motors illustrates blends of Nylon with polyurea offering appreciable impact strength.

In all the above patents, impact resistance was given paramount importance. Need for high impact materials has been growing as their applications in several gadgets is ever growing with more and more industrialization and development of new and innovative machines etc. The present invention is carried out to fulfill the requirement for a cost-effective polyolefins blends with very high impact strength with adequate stiffness and heat deflection temperature. The blends disclosed in this invention can be used in several applications, such as molded luggage, furniture, body panels and automotive components, to name a few.

### OBJECTS OF THE INVENTION

It is an object of the present invention to provide compatibilized blends of polypropylene block copolymer with EPDM or EPR and enhance miscibility by using a suitable compatibilizer.

It is another object of the present invention to provide compatibilized polyolefin blends or alloys using a twin-screw extruder or a Buss-co-kneader.

It is yet another object of the present invention to provide an alloy, with polypropylene copolymer, EPDM or EPR along with a suitable compatibilizer and other additives that exhibits very high (notched) Izod impact strength i.e., 60-90 kg. cm/cm, flexural moduls: 6,000-8,000 kg./cm², heat deflection temperature: 60-70° C., that would allow injection molding, compression molding, thermoforming and other conventional techniques to be applied for making end products.

It still another object of the present invention to provide a process for preparing a cost effective polyolefin alloy that is suitable for making end products exhibiting very high (notched) Izod impact strength along with moderate flexural modulus.

### SUMMARY OF THE INVENTION

The present invention relates to a process for the preparation of polypropylene copolymer alloys with EPDM or EPR along with a suitable compatibilizer and with or without a filler, melt-blended in a co-rotating twin-screw extruder or a Buss-co-kneader all together or in separate batches, keeping the extruder temperature in the range of 125-240° C. and the screw rotation speed in the range of 50-100 rpm.

In one embodiment of the invention, the polypropylene copolymer has a melt flow index in the range of 1-4 g/10 min. when tested at 230° C./2.16 kg. Load (according to ASTM D 1238); and EPDM with ethylene content in the range of 55-65 wt % possessing specific gravity: 0.86-090, and Mooney viscosity in the range of 36-77 [ML (1+4) 125° C.]; or EPR.

In one embodiment of the invention, the alloys consist of polypropylene copolymer as a dominant phase in the concentration range of 50-95 wt %.

In another embodiment of the invention, the alloy consists of a compatibilizer picked up from a group of two ionomers, styrene-ethylene/butylenes-styrene block copolymer (SEBS), styrene-acrylonitrile copolymer (SAN) and polypropylene copolymer grafted with maleic anhydride (PPBC-g-MAH) in the concentration I the range of 5-30 wt %.

In another embodiment of the invention, the alloys also consist of a natural filler, selected from the group consisting of calcium carbonate, talc and mica, of a preferred particle size in the range of 10-30 microns and with a suitable adhesion promoting surface treatment, in the concentration in range of 0-10 wt %.

In another embodiment of the invention, the alloys exhibit melt flow rate in the range of 2-5 g/10 min. when tested according to ASTM D 1238.

In a further embodiment of the invention, the alloys exhibit an Izod impact strength (notched specimen) in the range of 60-90 kg. cm/cm., when tested using injection molded 3.2 mm thick specimens (cut from the mid portions of the tensile bar of Type-I described in ASTM D638), and 50-70 kg. cm/cm when tested using 6.4 mm thick specimens, according to ASTM D 256.

In yet another embodiment of the invention, the alloys exhibit flexural modulus in the range of 6,000/8,000 kg/cm², when tested according to ASTM D 790.

In another embodiment of the invention, the alloys exhibit tensile strength in the range of 150-200 kg/cm², when tested according to ASTM D638, using injection molded specimens.

In another embodiment of the invention, the alloys show heat deflection temperature in the range of 60-70° C. with 4.6 kg the present invention to provide stress and 45-55° C. with 18.2 kgf stress according to ASTM D648.

### DETAILED DESCRIPTION OF THE INVENTION

A polyolefin polymer, viz., propylene ethylene block copolymer (PPBC) was the preferred matrix material for carrying out the present invention. It was obtained in the form of granules after adequately adding the stabilizers and antioxidants soon after polymerization. The granules were dried at 80±5° C. for two hours, preferably, in an oven with air circulation facility. An elastomer, ethylene propylene copoylmer rubber (EPR) or ethylene-propylene-diene monomer (EPDM), in a preferred form of granules, was also dried separately in an air circulating oven at a preferred temperature of 80±5° C. for a period of two hours. A compatibilizer selected from a group of two ionomers, styrene-ethylene/butylenes-styrene block copolymer (SEBS), styrene-acrylonitrile copolymer (SAN) and polypropylene copolymer grafted with maleic anhydride (PPBC-g MAH) was also dried at the same above temperature for the same time. Similarly, a natural filler, picked up among a group of mica, talc and calcium carbonate, preferably with a particle size in the range of 10-30 microns, was also dried at the same temperature, mentioned above, for the same time.

The object of melt blending, by means of a twin-screw extruder or Buss-co-kneader with a specially designed screw profile, is to break the elastomer into as fine particles as possible and to disperse them uniformly within the matrix of polypropylene block copolymer. This intimate associated with the presence of a suitable compatibilzer would yield an alloy that would exhibit desired mechanical properties, especially enhanced impact strength.

Dried PPBC, elastomer, compatibilizer, with or without a filler, along with other ingredients were tumble—mixed in the composition given here: PPBC: 50-59 wt %, EPR/EPDM: 5-50 wt %, compatibilizer (s) 5-30 wt %, filler: 0-10 wt % initiator, sulfur and other additives viz., glycerin mon-stearate, Tinuvin-770, Tinuvin-327, B-blend-225 and Chimmasorb, a combination of Tinuvin-622 and Benzophenone 0.01-0-10 phr each. This tumble-mixed dry mixture was extruded in a co-rotating twin-screw extruder (or a Buss-co-kneader) with a preferred screw profile under the following conditions: temperature range: 125-240° C., screw speed: 50-100 rpm, residence time: 0.5-5.0 min. The extrudate was dipped in cold circulating water and was chopped into granules of length 34 mm.

The extrudated granules were dried and then injection molded into ASTM standard test specimens for evaluating various performance properties such as tensile strength, flexural modulus, notched Izod impact strength and heat deflection temperature. Injection molding was carried out using a computer-controlled injection molding machine having four heating zones operating in the range: 130-230° C., injection pressure (applied in six stages) 60-100 kg/cm², injection time (in six stages) 2-6 sec. With screw speed (in two stages) in the range: 90-105 rpm. The standard test specimens, thus obtained were used for testing various mechanical properties of the alloys (mentioned above) following the ASTM standard test methods.

Other tests, such as melt flow index, crystallization kinetics (using Differential Scanning Calorimeter) and filler content (using Thermogravimetric Analyzer) were carried out using dry granules of the alloys. Dispersions of the elastomer and the filler were studied using thin microtomed sections cut from the injection molded flexural bars, using polarized optical microscope.

Rubber toughening is the most often used method of improving the impact resistance of polymers. In impact-modified materials, the composition of the constituents, their miscibility and the morphology influence the deformation and failure mechanisms in the blend. Particle size of the elastomer, its dispersion and its adhesion, (if required by the use of a suitable compatibilizer), with the matrix are also the important factors determining the toughness of the blend.

In the case of PPBC blends with EPDM/EPR, the elastomer was found to reduce the crystallinity of PPBC and significantly influence its failure mechanism. Both crazing and shear yielding, responsible mechanisms for plastic deformation in rigid polymers, found to be operating simultaneously in these blends. These two mechanisms are not mutually exclusive, but under certain conditions both operate simultaneously. They were found to be responsible for toughening the matrix materials, PPBC.

The present invention will now be described in greater detail by the following examples, the purpose of which is merely to illustrate the invention and not limit the scope thereof.

### EXAMPLE-1

Dried Granules of polypropylene copolymer 60 wt % were mixed with dried EPDM of concentration 20 wt %, a dried preferred compatibilizer, styrene-acrylonitrile copolymer (SAN) 5 wt %; PPBC grafted with maleic anhydride (PPBC-g-MAH) 5 wt % and a natural filler, preferably talc, 10 wt %, and all the constituents were tumble-mixed thoroughly. The dry mixture was extruded in a twin-screw extruder (or a Buss-co-kneader) with co-rotating screws, having a preferred screw profile with an objective of intimate mixing of the ingredients. The extruder was operated in the temperature range: 125-240° C. with screws rotating at a speed: 50-100 rpm. The extrudate strand (referred to as Alloy-A) was dipped in a trough of circulating cold water. The strand was later dried and granulated.

Standard ASTM test specimens were prepared by injection molding the dry granules of Alloy-A, using FRK-85, Knockner-Windsor injection molding machine applying the molding conditions given below in Table-I.

TABLE I
Typical Injection Molding Conditions for Preparing ASTM
Test Specimens of the Polyolefin alloys

| No. | Processing Parameters | Unit | Typical Value |
|---|---|---|---|
| 1. | Injection Pressure | kg/cm² | 60-100 |
| 2. | Injection Speed | mm/sec. | 7-12 |
| 3. | Temperature maintained | ° C. | 130-230 |
| 4. | Injection time | sec. | 2-6 |
| 5. | Cooling time | sec. | 30-90 |
| 6. | Screw speed | rpm. | 90-105 |

The performance properties of the alloys, injection molded under the above conditions, are given below in Table-II. For each property reported here, at least six specimens were tested and the average value was calculated.

TABLE II
Typical Properties of Alloy - A

| No. | Property | Unit | ASTM | Alloy-B |
|---|---|---|---|---|
| 1. | Melt flow index | g/10 min. | D 1238 | 4.2 |
| 2. | Tensile strength | kg/cm2 | D 638 | 167 |
| 3. | Tensile modules | kg/cm2 | D 638 | 8,958 |
| 4. | Flexural Strength | kg/cm2 | D 790 | 206 |
| 5. | Flexural modules0 | kg/cm2 | D 790 | 8,134 |
| 6. | Notched Izod impact strength | kg cm/cm. | D 256 | |
| | 3.2 mm thick specimen* | | | 62 |
| | 6.4 mm thick specimen | | | 55 |
| 7. | Heat deflection temperature | ° C. | D 648 | |
| | At 4.6 kgf stress | | | 75 |
| | At 18.2 kgf stress | | | 50 |

(*Middle portion of the injection molded ASTM standard tensile specimen was used)

### EXAMPLE-2

Moisture free granules of polypropylene copolymer 72 wt % were mixed with dried elastomer preferably, EPR of concentration 23 wt % and a dried compatibilizer, preferably, styrene-ethylene/butylenes-styrene block copolymer (SEBS) 5 wt %. All the constituents were thoroughly tumble mixed and then extruded in the same extruder under the same conditions mentioned above in Example-1. The extrude (referred to as Alloy B) was granulated and standard ASTM test specimens were prepared using the same injection molding machine under the same conditions mentioned in the above example. The properties Alloy-B are presented in Table-III.

TABLE III
Typical Properties of Alloy - B

| No. | Property | Unit | ASTM | Alloy-B |
|---|---|---|---|---|
| 1. | Melt flow index | g/10 min. | D 1238 | 2.34 |
| 2. | Tensile strength | kg/cm2 | D 638 | 160 |
| 3. | Tensile modules | kg/cm2 | D 638 | 7,964 |
| 4. | Flexural Strength | kg/cm2 | D 790 | 170 |
| 5. | Flexural modules0 | kg/cm2 | D 790 | 6,800 |
| 6. | Notched Izod impact strength | kg cm/cm. | D 256 | |
| | 3.2 mm thick specimen* | | | 73 |
| | 6.4 mm thick specimen | | | 69 |
| 7. | Heat deflection temperature | ° C. | D 648 | |
| | At 4.6 kgf stress | | | 65 |
| | At 18.2 kgf stress | | | 48 |

(*Middle portion of the injection molded ASTM standard tensile specimen was used)

### EXAMPLE-3

Polypropylene copolymer, 45 wt %, polypropylene copolymer grafted with maleic anhydride (PPCP-g-MAH), 45 wt %, and an elastomer; preferably EPDM, 10 wt %, were all weighed and dried. All the constituents were mixed thoroughly and then extruded in the same above-mentioned extruder under the same extruding conditions. The extrudate (referred to as Alloy-C) was granulated and standard ASTM test specimens were injection molded as mentioned in the previous examples. The properties of Alloy-C are given in Table-IV.

TABLE IV
Typical Properties of Alloy - B

| No. | Property | Unit | ASTM | Alloy-B |
|---|---|---|---|---|
| 1. | Melt flow index | G/10 min. | D 1238 | 7.2 |
| 2. | Tensile strength | Kg/cm2 | D 638 | 165 |
| 3. | Tensile modules | Kg/cm2 | D 638 | 7,758 |
| 4. | Flexural Strength | Kg/cm2 | D 790 | 180 |
| 5. | Flexural modules0 | Kg/cm2 | D 790 | 6,489 |
| 6. | Notched Izod impact strength | Kg. Cm/cm. | D 256 | |
| | 3.2 mm thick specimen* | | | 76 |
| | 6.4 mm thick specimen | | | 63 |
| 7. | Heat deflection temperature | ° C. | D 648 | |
| | At 4.6 kgf stress | | | 67 |
| | At 18.2 kgf stress | | | 50 |

(*Middle portion of the injection molded ASTM standard tensile specimen was used)

1. A thermoplastic polyolefin alloy having high (notched) Izod impact strength comprising a polypropylene block copolymer as a base polymer, an elastomer and a compatibilizer.

2. Polyolefin alloys as claimed in claim 1, exhibiting izod impact strength in the range: 60-90 kg. cm/cm, for notched specimens of thickness 3.2 mm, following the ASTM D256 test method using injection molded standard specimens.

3. Polyolefin alloy as claimed in claim 1, wherein said polypropylene block copolymer is a block copolymer of propylene and ethylene.

4. Polyolefin alloy as claimed in claim 1, wherein said elastomer is selected from a terpolymer made from ethylene propylene diene monomer(EPDM)/an ethylene propylene copolymer rubber (EPR).

5. Polyolefin alloy as claimed in claim 1, wherein said compatibilizer is selected from a group of two different ionomers, styrene-ethylene/butylene-styrene block copolymer (SEBS), styrene-acrylonitrile copolymer (SAN) and polypropylene block copolymer grafted with maleic anhydride (PPBC-g-MAH).

6. Polyolefin alloy as claimed in claim 1, wherein said polypropylene block copolymer is present in an amount of 50 to 95 wt % of said alloy.

7. Polyolefin alloy as claimed in claim 1, wherein said elastomer is present in a concentration range of 5 to 50 wt %.

8. Polyolefin alloy as claimed in claim 1, wherein said compatibilizer is present in an amount of from 5 to 30 wt %.

9. Polyolefin alloy as claimed in claim 1, further including a natural filler.

10. Polyolefin alloy as claimed in claim 9 wherein said filler is selected from the group consisting of mica, talc and calcium carbonate.

11. Polyolefin alloy as claimed in claim 9, wherein said filler is present in the concentration range of from 0-10 wt %.

12. A thermoplastic polyolefin alloy having high (notched) Izod impact strength comprising a base polymer selected from a block copolymer of propylene and ethylene (PPBC) in the concentration range of 50 to 59 wt %; an elastomer comprising, a terpolymer made from ethylene propylene diene monomer (EPDM)/an ethylene propylene copolymer rubber (EPR) in the concentration range of 5-50 wt %; a compatibilizer selected from the group consisting of two different ionmers, styrene-ethylene/butylenes-styrene block copolymer (SEBS), styrene-acrylonitrile copolymer (SAN) and polypropylene block copolymer grafted with maleic anhydride (PPBC-g-MAH) in a concentration range of 5 to 30 wt % and natural filler selected from a group consisting of mica, talc and calcium carbonate in the concentration range of 0 to 10 wt %.

13. Polyolefin alloy as claimed in claim 12, when heated in differential, scanning calorimeter at a uniform heating rate of 110° C./min. in nitrogen environment, exhibit 2 to 3 endothermic peaks in the range: 90-167° C.

14. Polyolefin alloy as claimed in claim 12, having exothermic major peak in the temperature range of 115-25° C. followed by a minor peak in the range of 113 to 125° C. with total ΔH value in the range: 55 of 75 J/g, when heated in differential scanning calorimeter at a uniform heating rate of 10° C./min, in nitrogen environment, up to 200° C. and cooled after holding isothermally for 3 min.

15. Polyolefin alloy as claimed in claim 12, having melt flow indices in the range: 2-5 g/10 min. when tested according to ASTM D1238 standard method using dried granules.

16. Polyolefin alloy as claimed in claim 12, having tensile strength in the range of 150 to 200 kg/cm² when tested according to ASTM D638, using injection molded test specimens.

17. Polyolefin alloy as claimed in claim 12, exhibiting tensile modulus in the range of 7,000 to 8,000 kg/cm², when tested according to ASTM D638, using injection molded test specimens.

18. Polyolefin alloy as claimed in claim 12, exhibiting flexural strength in the range of 160 to 200 kg/cm², when tested according to ASTM D790, using injection molded specimens.

19. Polyolefin alloy as claimed in claim 12, having flexural modules in the range of 6,000 to 8,000 kg/cm², when tested according to ASTM D790, using injection molded specimens.

20. Polyolefin alloy as claimed in claim 12, having heat deflection temperature in the range of 60-70° C. with 4.6 lcgf stress when tested according to ASTM D648, using injection molded test specimens.

21. Polyolefin alloy as claimed in claim 12, exhibiting heat deflection temperature in the range: 45-55° C. with 18.2 kgf stress when tested according to ASTM D648, using injection molded test specimens.

22. A process for the preparation of a thermoplastic polyolefin alloy having high (notched) Izod impact strength which comprises melt blending a polypropylene block copolymer, a terpolymer and a compatibilizer, with or without a natural filler.

23. A process as claimed in claim 22, wherein said melt blending is carried out in in a twin screw extruder or a Buss-co-kneader.

24. A process as claimed in claim 22, wherein said polypropylene block copolymer is a block copolymer of propylene and ethylene.

25. A process as claimed in claim 22, wherein said elastomer is selected from a terpolymer made from ethylene propylene diene monomer (EPDM)/an ethylene propylene copolymer rubber (EPR).

26. A process as claimed in claim 22, wherein said compatibilizer is selected from a group of two different ionomers, styrene-ethylene/butylene-styrene block copolymer(SEBS), styrene-acrylonitrile copolymer (SAN) and polypropylene block copolymer grafted with maleic anhydride (PPBC-g-MAH).

27. A process as claimed in claim 22, wherein said polypropylene block copolymer is present in an amount of 50 to 95 wt % of said alloy.

28. A process as claimed in claim 22, wherein said elastomer is present in a concentration range of 5 to 50 wt %.

29. A process as claimed in claim 22, wherein said compatibilizer is present in an amount of from 5 to 30 wt %.

30. A process as claimed in claim 22, further including a natural filler.

31. A process as claimed in claims 30, wherein said filler is selected from the group consisting of mica, talc and calcium carbonate.

32. A process as claimed in claim 31, wherein said filler is present in the concentration range of from 0-10 wt %.

33. A process as claimed in claim 23 wherein said extruder temperature is maintain at in the range of 125 to 240° C.

34. A process as claimed in claim 23 wherein the twin-screwextruder/Buss-co-lsneader is operated with the screws rotating at a speed of 50-100 rpm.

35. A process as claimed in claim 22 wherein the melt blending is carried out at a residence time of 0.5 to 5.0 min.

36. An article of manufacture whenever made of the polyoelfin alloy as claimed claim 1.
